(19) United States
(12) Patent Application Publication
(10) Pub. No.: US 2016/0135434 A1
(43) Pub. Date: May 19, 2016

(54) EGG INCUBATOR

(71) Applicant: Miller Manufacturing Company, Eagan, MN (US)

(72) Inventor: John Bodenhamer, Shakopee, MN (US)

(73) Assignee: MILLER MANUFACTURING COMPANY, Eagan, MN (US)

(21) Appl. No.: 14/540,149

(22) Filed: Nov. 13, 2014

(51) Int. Cl. A01K 41/02; A01K 41/04

(52) U.S. Cl. CPC A01K 41/023; A01K 41/04

(57) ABSTRACT

An insulated egg incubator having a base pan with a bottom into which eggs are placed for incubation until hatching. Water channels are evenly disbursed in the bottom of the base pan for adding water and humidity to the incubator. A plastic molded screen is located in the base pan above the water channels to support the eggs. A top lid of a smaller dimension than the base pan is provided for completely nesting upside down into the base pan for shipping of the incubator. A window is in the top lid for viewing within the incubator. An insulated heater with a plastic fan assembly is mounted to the inside of the top lid. A digital control unit is mounted in the top lid with a rectifier connected to and controlling the on-off modes of the heater and the fan. A thermistor is provided inside the top lid and connected to the control unit placeable on the eggs for displaying the temperature within the incubator at the top of the eggs and inputting temperature readings to the control unit for operation of the heater. A humidity sensor is located inside the top lid and connected to the control unit for displaying the humidity within the incubator. A power cord with a plug is provided for connection and supply of electrical power to the control unit.

### BACKGROUND OF THE INVENTION

The present invention relates to an egg incubator, and more particularly, to an egg incubator with a highly controlled and maintained environment conducive to high production of hatched eggs.

Incubation of eggs is popular with poultry hobbyists and hobby farmers. Typically, up to fifty eggs are incubated at one time in a table top incubator. Prior art examples of such incubators are disclosed in U.S. Pat. Nos. 5,148,773; Des. 381,432; 5,690,055; 7,618,808; Des. 637,292; 7,966,972 and 7,950,350.

Such incubators require set up of a thermometer viewable within the incubator in an attempt to estimate the temperature of the eggs. Next the heating element needs to be turned on and regulated for a duration until an ideal temperature is reached and maintainable at that temperature over the duration of the incubation period. Temperature fluctuations are greatly undesirable during hatching. Incubating eggs with live embryos also produce their own heat later during their incubation period. The greater numbers of eggs in the incubator means more heat is generated by the eggs themselves all of which must be taken into consideration in moderating the temperature within the incubator. Humidity control is also crucial so that the eggs do not dry out during their incubation period which might range between 14 and 37 days depending upon the species of eggs that are being incubated. Chickens take 21 days of incubation for a typical hatch. Fresh air with oxygen is also critical to the hatching process as to not suffocate the growing embryos.

Incubators of the prior art of the table top type are often bulky. They may be of a cylindrical shape and often quite tall. They are not easily collapsed for easy space saving shipping and storage. They may generally operate on 120 volts. Exposed heating and fan components within the incubator may be very hot if touched as to burn a person operating the incubator.

There is a need for an egg incubator that will offer a highly controlled and maintained environment conducive to high production of hatched eggs. The observation of the temperature and humidity should be readily viewable. The temperature within the incubator should be taken from the top of the eggs. The regulation of the temperature, once set to desired degrees, should be automatic. The temperature and air flow should be even throughout the interior of the incubator. The addition of water to add humidity should be simple without fully opening the incubator and subjecting the eggs to a significant temperature fluctuation. The incubator should be collapsible to a compact size for storage or shipping. The heating element and the fan should not get excessively hot as to burn the operator if accidently touched.

### SUMMARY OF THE INVENTION

An insulated egg incubator having a base pan with a bottom into which eggs are placed for incubation until hatching. Water channels are evenly disbursed in the bottom of the base pan for adding water and humidity to the incubator. A plastic molded screen is located in the base pan above the water channels to support the eggs. A top lid of a smaller dimension than the base pan is provided for completely nesting upside down into the base pan for shipping of the incubator. A window is in the top lid for viewing within the incubator. An insulated heater with a plastic fan assembly is mounted to the inside of the top lid. A digital control unit is mounted in the top lid with a rectifier connected to and controlling the on-off modes of the heater and the fan. A thermistor is provided inside the top lid and connected to the control unit placeable on the eggs for displaying the temperature within the incubator at the top of the eggs and inputting temperature readings to the control unit for operation of the heater. A humidity sensor is located inside the top lid and connected to the control unit for displaying the humidity within the incubator. A power cord with a plug is provided for connection and supply of electrical power to the control unit.

A principal object and advantage of the present invention is that it will offer a highly controlled and maintained environment conducive to high production of hatched eggs.

Another object and advantage of the present invention is that the temperature and humidity is readily viewable when near the incubator.

Another object and advantage of the present invention is that the temperature within the incubator is taken and monitored from the top of the eggs.

Another object and advantage of the present invention is that, after the desired temperature is set, the temperature is maintained constant within 1.75° Fahrenheit (F) of the temperature set point.

Another object and advantage of the present invention is that temperature and air flow is even throughout the interior of the incubator.

Another object and advantage of the present invention is that adding water to add humidity is simple without fully opening the incubator and subjecting the eggs to a significant temperature fluctuation.

Another object and advantage of the present invention is that the incubator is collapsible to a compact size for storage and shipping.

Another object and advantage of the present invention is that the heating element and the fan should will not get excessively hot as to burn the operator if accidently touched.

### BRIEF DESCRIPTION OF THE DRAWINGS

FIG. 1 is a perspective view of the egg incubator with the top lid mounted onto the base pan for operation;

FIG. 2 is a perspective view of the egg incubator with the top lid nested into to the base pan for shipping and storage in a box;

FIG. 3 is a bottom plan view of the inside of the top lid;

FIG. 4 is a top plan view of the base pan;

FIG. 5 is another top plan view of the base pan with the plastic molded screen in place for supporting eggs;

FIG. 6 is a perspective view of a condition of the top lid ajar from the base pan for adding water to the incubator;

FIG. 7 is a cross section view of the invention taken along lines 7-7 of FIG. 1;

FIG. 8 is a cross section view of the invention taken along lines 8-8 of FIG. 1;

FIG. 9 is a top plan view of the control unit mounted in the top lid;

FIG. 10 is a perspective view of the heater and fan assembly;

FIG. 11 is an exploded view of the heater and fan assembly; and

FIG. 12 is a flow chart of the method of incubating eggs.

### DETAILED DESCRIPTION

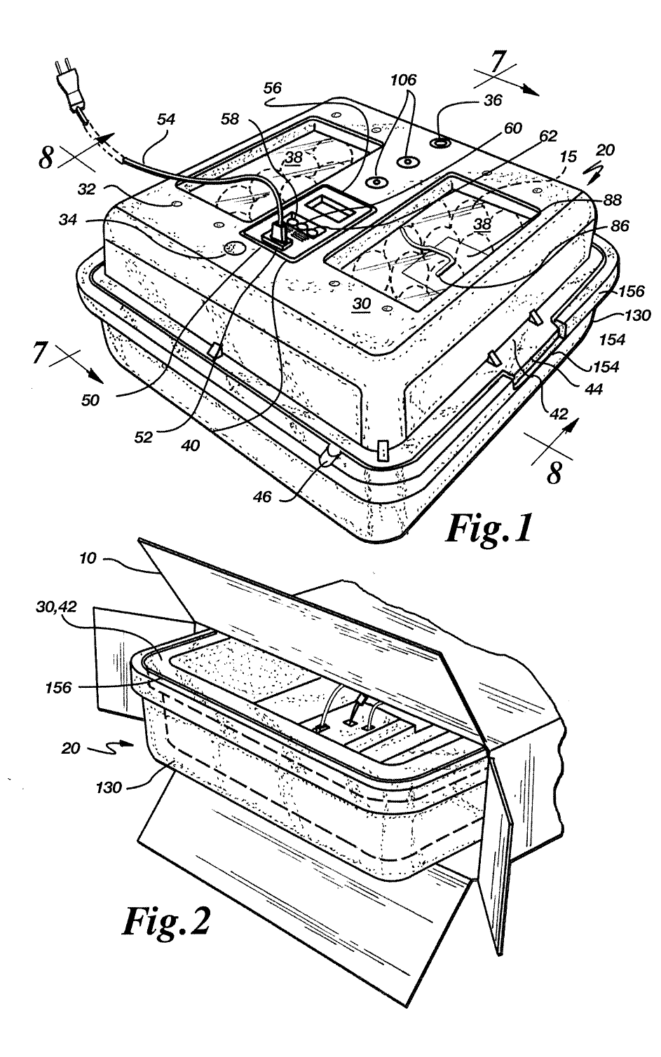

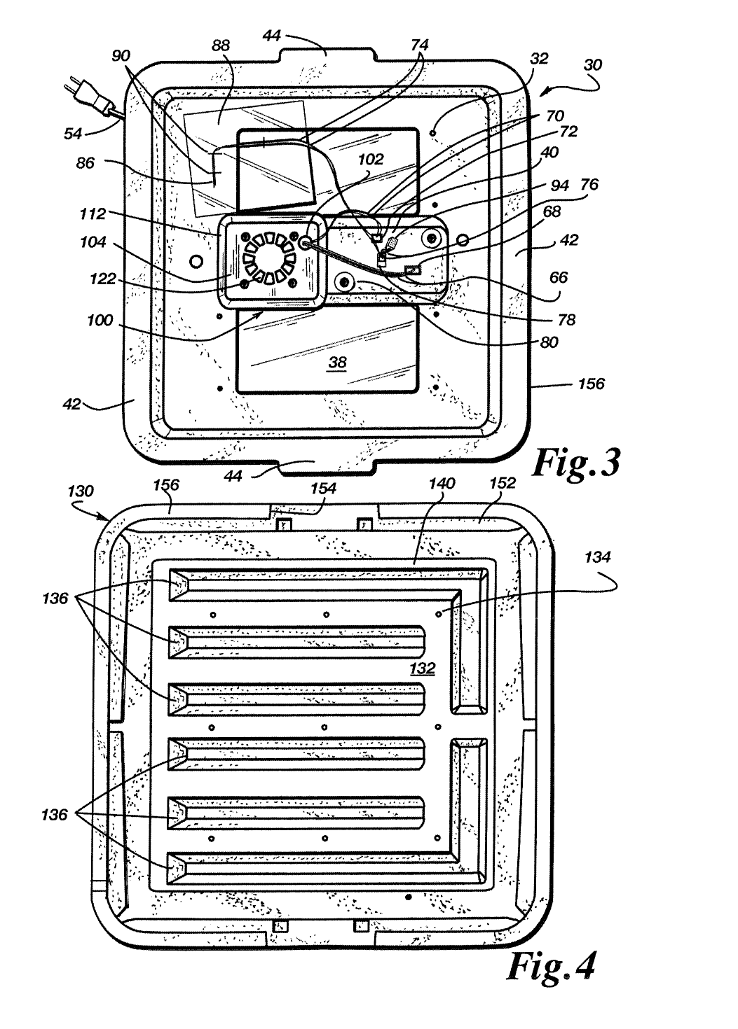

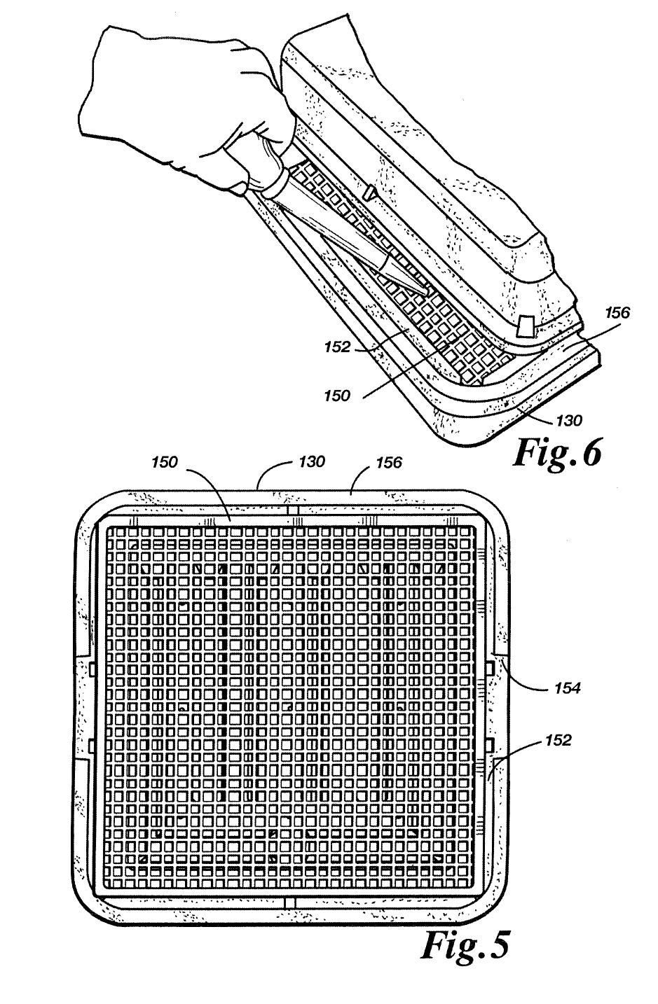

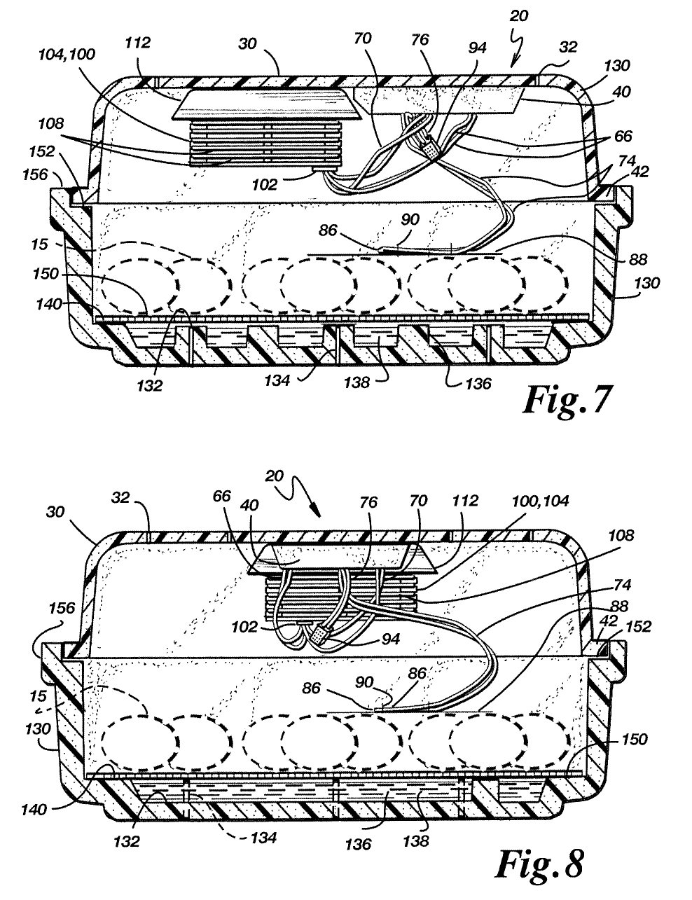

Referring to FIGS. 1 through 6, the general construction of the egg incubator 20 may be understood. The incubator is suitably made of an insulative material such as foam or stryfoam. The incubator 20 is shipped and may be stored in a box 10 in a very compact condition (FIG. 2). This is possible because the top lid 30 is slightly of a dimension smaller than the base pan 130. The lid 30 has an outer flange 42 which rests on the lid ledge 152 of the base pan 130 in a fashion that fully supports and protects all the electronics of the incubator 30 when in its storage or shipping condition.

The lid 30 has small vent holes 32 therethrough and large vent holes 34 suitably fit with plugs 36 which are not needed in the early stages of incubation. The lid 30 has two plastic windows 38 for viewing of the interior of the incubator 20 during operation. A recess 42 is in the lid 30 for flush mounting of the control unit 50 with fasteners 80. Outer flange 42 cooperates with base pan 130 lid ledge 152 to easily align lid 30 with base pan 130 for a sealed arrangement during operation and for nesting for compact storage or shipping. Handles 44 are provided for lifting the lid 30 off of the base pan 130. A cord recess 46 is provided is provided in case the operator wishes to add an electric egg turner into the incubator 20.

Base pan 130 has a bottom 132 with a series of small vent holes 134 to cooperate with the lid vent holes 32 and 34 as to provide ventilation and oxygen to the incubating eggs 15. Six water channels 136 are evenly located in bottom 132 and evenly distributed and space across the entire bottom 132 of the base pan 130. These channels 136 are unique in that they may be filled with water 138 from the front side of the incubator 20 by simply lifting lid 30 slightly and moving it backwards a very short span to expose the channels 136 without completely removing the lid 30 from the base pan 130. A turkey baster works well for adding water 138. This arrangement assures that there is not a substantial temperature loss in the incubator 20 when filling the water channels 136.

The base pan 130 also has a screen ledge 140 for supporting plastic molded screen 150 along with bottom portions 132. The plastic screen advantageously has no sharp edges to cut the operator or the hatched chicks, is easily cleanable, as in a dish washer, and will not harbor bacteria. The lid ledge 152 is provided to provide support for the outer flange 42 of the lid 30 while the rim secures the lid 30 properly in place.

FIGS. 7 and 8 display the incubator 20 in cross sections taken along lines 7-7 and 8-8 of FIG. 1 ready for in operation. The top lid flange 42 is nested in the lid ledge 152 of the base pan 130 and held in proper alignment by rim 156. The 120 VAC control unit 50 with an internal rectifier (not shown) in nested down into the recess 40 with three holes in its floor for the two heater control wires 66 from the 120 VAC or 24 VDC heater/fan assembly 100 with a plastic fan blade 120 to plug into the control unit 50 via quick plug-in 68. Two fan control wires 70 from the 12 VDC fan assembly 100 are plugged into the control unit 50 via quick plug-in 72. Two thermistor wires 74 from the 5 VDC thermistor 86 are adjacent two humidity sensor wires 76 from 5 VDC humidity sensor 94, all four of which are plugged into the control unit 50 via quick plug-in 78. Thermistor 86 is mounted on plastic mylar sheet 88 by retainers 90. Thermistor 86 is movable by wires 74 and is appropriately placed on top of eggs 15 which rest on plastic molded screen 150.

Air vents 32 and 134 allow air to pass through the incubator 20. Large air vents 34 maybe have plugs 36 removed late in the incubation when the embryos are producing heat. Water 138 is located in water channels 136 to provide humidity to the interior of the incubator 20 to assure that the eggs 15 do not dry out.

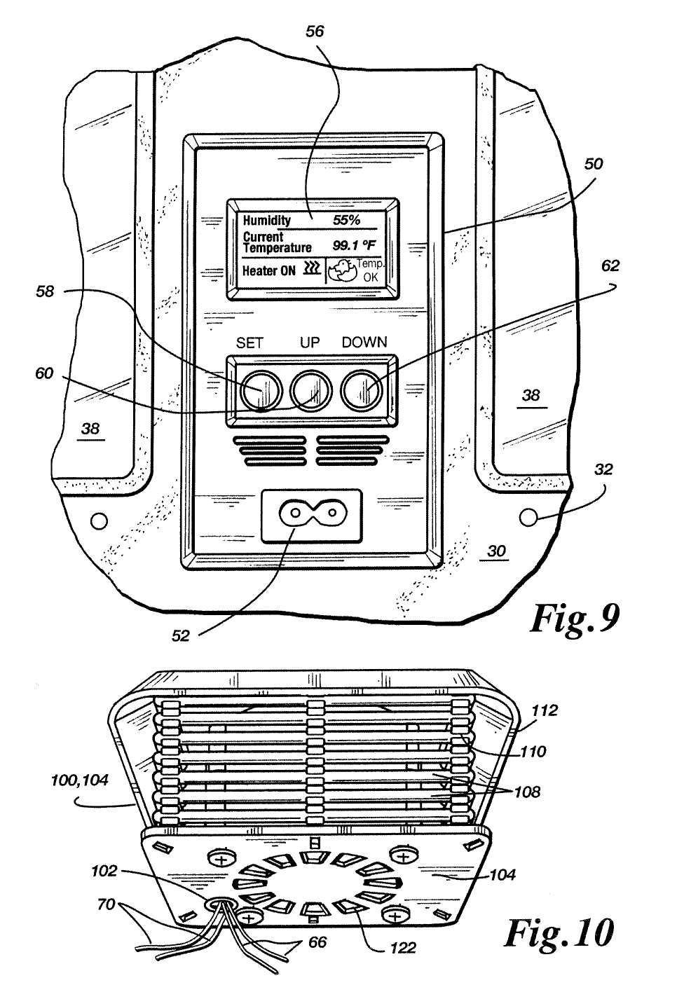

FIG. 9 is a plan view of the 120 VAC control unit 50 from which its setting may be made and understood by viewing. The set button 58 is for setting the desired temperature of the interior of the incubator 20. Preferably the temperature is preset to 99.5° F. which is ideal for chicken eggs. After the set button is pressed, the ideal temperature may be changed for other species of birds by using the up button 60 or the down button 62. The LED panel 56 shows the status of the environment within the incubator to include the humidity, current temperature, status of the heater and whether the current temperature is acceptable for the species of bird eggs within the incubator 20. Power control socket 52 readily accepts ‘plug and play’ power cord 54 for easy start up and take down of the incubator 20.

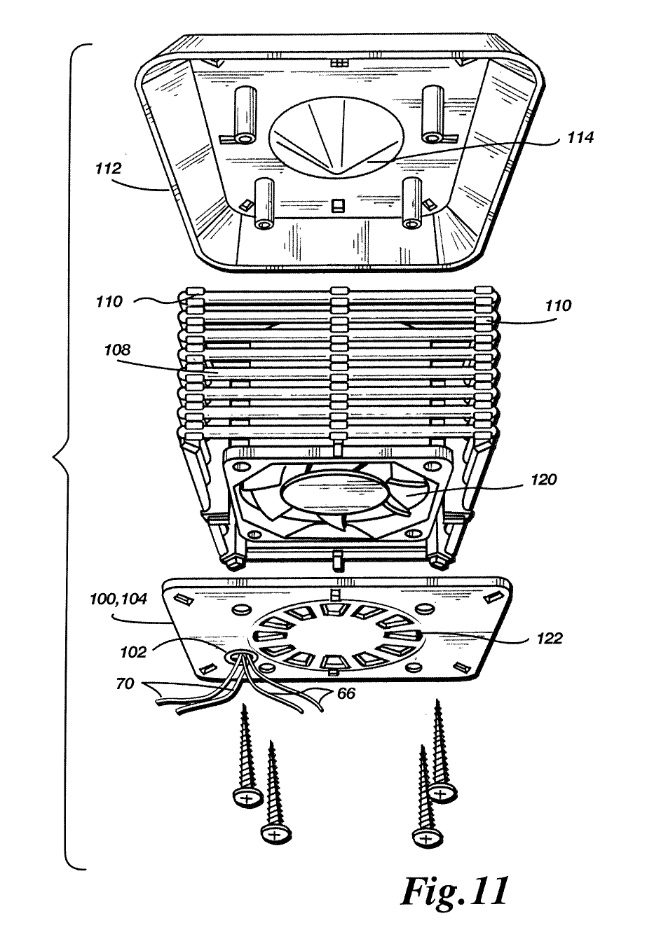

FIGS. 10 and 11 show the features of the unique heater with fan assembly 100. Power wires 66 and 70 pass through wear-resistant grommet 102 into frame housing 104 which is secured to top lid 30 by fasteners 106. Insulated heater coils 108 are wrapped around housing 104 in spaced relationship with the aid of slots 110. Air ramp defector 112 directs heat downwardly from lid 30. Internally of assembly 100 at its ceiling is located air deflector cone 114 which directs flowing air from plastic fan 120 drawn in through air inlets 114 out through heat coils 108 and further directed downwardly by aid of the air ramp deflector 112. Plastic fan blades will not absorb heat and the heater coils 108 are insulated so as to not burn the operator if touched. In the case where no fan 120 is used, deflectors 112 and/or 114 move air upwardly and then downwardly into the far corners of the incubator 20.

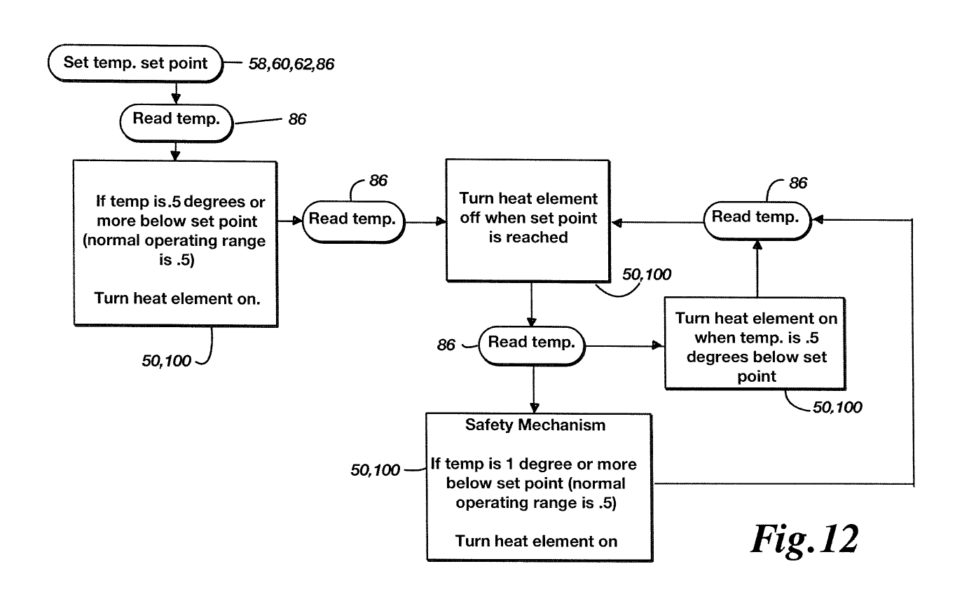

FIG. 12 shows the method of operation and incubating eggs with egg incubator 20. Initially, power is given to control unit 50 by power cord 54 being plugged into socket 52. The ideal temperature is automatically set at 99.5° F. for chicken eggs. Adjustments may be made with set button 58 and up and down temperature buttons 60 and 62 as is read on LED screen 56. Holding both the up and down buttons 60 and 62 toggles the control unit 50 to operate in Fahrenheit (F) or Celsius (C). The actual or current temperature is read by and within the incubator 20 by thermistor 86 which is fed to control unit 50. After the temperature set point is selected, the control unit 50 determines if the temperature is 0.5° or more below the set point. If so, the heat element or coils 108 are turned on. The normal operating range is 0.5° F. Again the temperature is read by thermistor 86. If the temperature is 1° F. or more below the set point, meaning the last reading may have been lost, the safety mechanism loop operates to make sure that the heater coils 108 are turned on. The next reading occurs. If the temperature is 5° F. or more above the set point, the heater coils are turned off. This cycle of reading and regulation is completed every 200 microseconds with the software using a 0.5° F. on/off cycle. That is, the temperature is read 300 times a minute for ultimate control and regulation. The hysteresis of the controller 50 is about 100 microseconds which is one cycle or circle time.

Although the present invention has been shown and described with respect to a best mode embodiment thereof, it should be understood by those skilled in the art that the forgoing and various other changes, omissions, and additions in the form and detail thereof may be made therein without departing from the spirit and scope of the present invention of the claims below.

What is claimed:

1. An insulated egg incubator, comprising:
a) a base pan with a bottom into which eggs are placed for incubation until hatching;
b) water channels evenly disbursed in the bottom of the base pan for adding water and humidity to the incubator;
c) a plastic molded screen located in the base pan above the water channels to support the eggs;
d) a top lid of a smaller dimension than the base pan for completely nesting upside down into the base pan for shipping of the incubator;
e) a window in the top lid for viewing within the incubator;
f) a heater assembly mounted to the inside of the top lid;
g) a digital control unit controls the on-off modes of the heater;
h) a thermistor inside the top lid and connected to the control unit placeable on the eggs for displaying the temperature within the incubator at the top of the eggs and inputting temperature readings to the control unit for operation of the heater and the fan;
i) a humidity sensor inside the top lid and connected to the control unit for displaying the humidity within the incubator; and
j) a power cord for connection and supply of electrical power to the control unit.

2. The incubator of claim 1, wherein the heater assembly comprises a frame housing with an insulated heater core wrapped therearound in spaced relationship to itself and a deflector mounted to the frame to deflect moving, heated air evenly downwardly throughout the incubator.

3. The incubator of claim 1 wherein the deflector is a cone to move air from the incubator, into the frame housing and out of the frame housing through the heater core.

4. The incubator of claim 2 wherein the deflector is a mounted on the frame housing and outside of the heater core to move heated air away from the inside of the top lid and throughout the incubator.

5. The incubator of claim 2 wherein the deflector is a cone mounted above a constantly running fan in the direction of air flow from the fan to move air out of the frame housing and through the heater core and a second deflector is a mounted on the frame housing above the fan and outside of the heater core to move heated air away from the inside of the top lid and further throughout the incubator.

6. The incubator of claim 1 further comprising room air flow vents in the top lid and the base pan.

7. The incubator of claim 1 wherein the thermistor is moveable within the incubator and is mounted on a clear plastic sheet to support the thermistor on top of the eggs.

8. The incubator of claim 1 wherein the control unit is recess mounted in the top lid in a flush arrangement.

9. The incubator of claim 1 wherein the control unit has an LED display screen that displays the humidity, temperature and the heater on-off mode.

10. An insulated egg incubator, comprising:
a) a base pan with a bottom into which eggs are placed for incubation until hatching;
b) water channels evenly disbursed in the bottom of the base pan for adding water and humidity to the incubator;
c) a plastic molded screen located in the base pan above the water channels to support the eggs;
d) a top lid of a smaller dimension than the base pan for completely nesting upside down into the base pan for shipping of the incubator;
e) a window in the top lid for viewing within the incubator;
f) a heater with a fan assembly mounted to the inside of the top lid wherein the heater and fan assembly comprises a frame housing with an insulated heater core wrapped therearound in spaced relationship to itself and the fan is mounted within the housing inside of the heater core with a deflector mounted to the frame to deflect moving air evenly downwardly throughout the incubator;
g) a digital control unit controlling the on-off modes of the heater;
h) a thermistor inside the top lid and connected to the control unit placeable on the eggs for displaying the temperature within the incubator at the top of the eggs and inputting temperature readings to the control unit for operation of the heater and the fan;
i) a humidity sensor inside the top lid and connected to the control unit for displaying the humidity within the incubator; and
j) a power cord with a plug for connection and supply of electrical power to the control unit.

11. The incubator of claim 10 wherein the deflector in the shape of a cone mounted above the fan in the direction of air flow from the fan to move air out of the frame housing and through the heater core.

12. The incubator of claim 10 wherein the deflector is a mounted on the frame housing above the fan and outside of the heater core to move heated air away from the inside of the top lid and throughout the incubator.

13. The incubator of claim 10 wherein the deflector is a cone mounted above the fan in the direction of air flow from the fan to move air out of the frame housing and through the heater core and a second deflector is a mounted on the frame housing above the fan and outside of the heater core to move heated air away from the inside of the top lid and further throughout the incubator.

14. The incubator of claim 10 further comprising room air flow vents in the top lid and the base pan.

15. The incubator of claim 10 wherein the thermistor is moveable within the incubator and is mounted on a clear plastic sheet to support the thermistor on top of the eggs.

16. The incubator of claim 10 wherein the control unit is recess mounted in the top lid in a flush arrangement.

17. The incubator of claim 10 wherein the control unit has an LED display screen that displays the humidity, temperature and the heater on-off mode.

18. An insulated egg incubator, comprising:
a) a base pan with a bottom into which eggs are placed for incubation until hatching;
b) water channels evenly disbursed in the bottom of the base pan for adding water and humidity to the incubator;
c) a plastic molded screen located in the base pan above the water channels to support the eggs;
d) a top lid of a smaller dimension than the base pan for completely nesting upside down into the base pan for shipping of the incubator;
e) a window in the top lid for viewing within the incubator;
f) a heater with a fan assembly mounted to the inside of the top lid wherein the heater and fan assembly comprises a frame housing with an insulated heater core wrapped therearound in spaced relationship to itself and the fan is mounted within the housing inside of the heater core with a deflector mounted to the frame to deflect moving air evenly downwardly throughout the incubator;
g) a digital control unit with a rectifier connected to and controlling the on-off modes of the heater and the fan wherein the control unit has an LED display screen that displays the humidity, temperature and the heater on-off mode;
h) a thermistor inside the top lid and connected to the control unit placeable on the eggs for displaying the temperature within the incubator at the top of the eggs and inputting temperature readings to the control unit for operation of the heater wherein the thermistor is moveable within the incubator and is mounted on a clear plastic sheet to support the thermistor on top of the eggs;
i) a humidity sensor inside the top lid and connected to the control unit for displaying the humidity within the incubator; and
j) a power cord with a plug for connection and supply of electrical power to the control unit.

19. The incubator of claim 18 wherein the deflector in the shape of a cone mounted above the fan in the direction of air flow from the fan to move air from the incubator, into the frame housing and out of the frame housing and through the heater core.

20. The incubator of claim 18 wherein the deflector is a mounted on the frame housing above the fan and outside of the heater core to move heated air away from the inside of the top lid and throughout the incubator. The incubator of claim 18 wherein the deflector is a cone mounted above the fan in the direction of air flow from the fan to move air out of the frame housing and through the heater core and a second deflector is a mounted on the frame housing above the fan and outside of the heater core to move heated air away from the inside of the top lid and further throughout the incubator.

22. The incubator of claim 18 further comprising room air flow vents in the top lid and the base pan.

23. The incubator of claim 18 wherein the control unit is recess mounted in the top lid in a flush arrangement.

24. The incubator of claim 18 wherein the control unit has an LED display screen that displays the humidity, temperature and the heater on-off mode.

25. An insulated egg incubator, comprising:
a) a base pan with a bottom into which eggs are placed for incubation until hatching;
b) water channels evenly disbursed in the bottom of the base pan for adding water and humidity to the incubator;
c) a plastic molded screen located in the base pan above the water channels to support the eggs;
d) a top lid of a smaller dimension than the base pan for completely nesting upside down into the base pan for shipping of the incubator;
e) a window in the top lid for viewing within the incubator;
f) a heater with a 12 VDC fan assembly with a plastic fan blade mounted to the inside of the top lid wherein the heater and fan assembly comprises a frame housing with an insulated heater core wrapped therearound in spaced relationship to itself and the fan is mounted within the housing inside of the heater core with a deflector mounted to the frame to deflect moving, heated air evenly downwardly throughout the incubator wherein the deflector is a cone mounted above the fan blade in the direction of air flow from the fan blade to move air out of the frame housing and through the heater core and a second deflector is a mounted on the frame housing above the fan blade and outside of the heater core to move heated air away from the inside of the top lid and further throughout the incubator;
g) a 120 VAC digital control unit controlling the on-off modes of the heater and having a rectifier connected to and powering the fan wherein the control unit has an LED display screen that displays the humidity, temperature and the heater on-off mode;
h) a 5 VDC thermistor inside the top lid and connected to the control unit placeable on the eggs for displaying the temperature within the incubator at the top of the eggs and inputting temperature readings to the control unit for operation of the heater and the fan wherein the thermistor is moveable within the incubator and is mounted on a clear plastic sheet to support the thermistor on top of the eggs;
i) a 5 VDC humidity sensor inside the top lid and connected to the control unit for displaying the humidity within the incubator; and
j) a 120 volt cord with a plug for connection and supply of electrical power to the control unit.

26. The incubator of claim 25 further comprising room air flow vents in the top lid and the base pan.

27. The incubator of claim 25 wherein the control unit is recess mounted in the top lid in a flush arrangement.

28. A method of incubating eggs within an egg incubator having a base pan with a bottom into which eggs are placed for incubation until hatching, water channels evenly disbursed in the bottom of the base pan for adding water and humidity to the incubator, a top lid of a smaller dimension than the base pan for completely nesting upside down into the base pan for shipping of the incubator, a heater with a fan assembly mounted to the inside of the top lid, a digital control unit with a rectifier connected to and controlling the on-off modes of the heater and the fan, a thermistor inside the top lid and connected to the control unit placeable on the eggs for displaying the temperature within the incubator at the top of the eggs and inputting temperature readings to the control unit for operation of the heater and the fan, a humidity sensor inside the top lid and connected to the control unit for displaying the humidity within the incubator, and a power cord for connection and supply of electrical power to the control unit, the method comprising the following steps:
a) the control unit is powered up by the power cord;
b) the ideal hatching temperature known as the temperature set point is set;
c) the heater is turned on;
d) the current temperature within the incubator is read by the thermistor which is fed to control unit;
e) the control unit determines if the temperature is 0.5° F. or more below the set point, and if so, the heater is left on;
f) the temperature is read, and if the temperature is at set point, the heater is turned off;
g) the control unit determines if the temperature is 0.5° F. or more below the set point, and if so, the heater is turned on;
h) If step g) above is missed, the temperature is read, and if the temperature is 1° F. or more below the set point, the heater is turned on; and
g) go to step f).

29. The method of claim 28 wherein the steps of reading and regulation of d), e) f), g) and h) are completed every 200 microseconds.

30. The method of claim 28 wherein the temperature is read approximately 300 times a minute.

31. The method of claim 28 wherein the controller has a hyteresis of approximately 100 microseconds.
